(19) United States
(12) Patent Application Publication
(10) Pub. No.: US 2003/0129461 A1
(43) Pub. Date: Jul. 10, 2003

(54) Method for operating a polymer electrolyte membrane fuel cell system, and an associated PEM fuel cell system

(76) Inventors: Rolf Bruck, Bergisch Gladbach (DE); Joachim Grosse, Erlangen (DE); Jorg-Roman Konieczny, Siegburg (DE); Meike Reizig, Bonn (DE)

Correspondence Address: LERNER AND GREENBERG, P.A., P.O BOX 2480, HOLLYWOOD, FL, 33022-2480, US

(21) Appl. No.: 10/329,973

(22) Filed: Dec. 26, 2002

Related U.S. Application Data
(63) Continuation of application No. PCT/DE01/02305, filed on Jun. 22, 2001.

(30) Foreign Application Priority Data
Jun. 26, 2000 (DE) 100 31 062.1

(51) Int. Cl. H01M 8/04; H01M 8/10

(52) U.S. Cl. 429/13; 429/24; 429/26; 429/32; 429/38

(57) ABSTRACT

A PEM fuel cell with a heating element, a method for operating the PEM fuel cell system, and a PEM fuel cell system includes the heating element having an integrated thermosensor that, substantially, can prevent the temperature of the cell/system from dropping below the freezing point of the electrolyte.

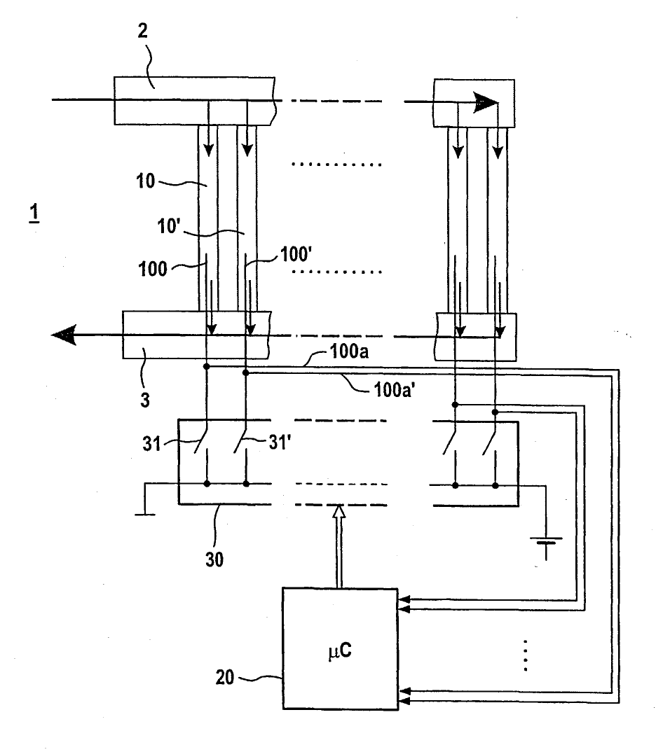

### CROSS-REFERENCE TO RELATED APPLICATION

This application is a continuation of copending International Application No. PCT/DE01/02305, filed Jun. 22, 2001, which designated the United States and was not published in English.

### BACKGROUND OF THE INVENTION

### FIELD OF THE INVENTION

The invention relates to methods for operating a polymer electrolyte membrane (PEM) fuel cell system, and to the associated PEM fuel cell system.

A PEM fuel cell having an integrated heating element is disclosed in the prior but not previously published document International publication WO 00/59058 A1. Therein, the heating element is started first of all during cold starting. The system has a disadvantage in that no apparatus is provided to prevent the temperature of the fuel cell system from falling below the freezing point of the electrolyte, for example, by starting of the heating element.

A fuel cell battery has an electrolyte for each fuel cell unit, for example in the case of a PEM fuel cell, a membrane, or a matrix in which the proton-conductive connection (for example, water) and/or its own dissociating connection (for example, phosphoric acid) is bound. At a temperature below 0° C. when using water as the electrolyte and at a temperature of approximately 42° C. when using phosphoric acid as the electrolyte, the membrane resistance of the PEM fuel cell rises suddenly by a factor of 2 or 3 powers of ten as a result of the freezing of the stored water or of the stored phosphoric acid. This means that auto-thermal heating of a fuel cell unit, particularly when the PEM fuel cell is being operated at raised temperatures, is not possible without further measures.

To solve this problem, when the ambient temperature is low, either the battery (even without being used) is operated at a minimum load so that the temperature does not fall below the freezing point, or a thermal sensor can be installed so that the battery responds at the moment when the temperature falls sufficiently that the electrolyte resistance threatens to rise suddenly, raising the temperature to above the freezing point of the electrolyte by operation of the fuel cell.

Japanese Patent document 05-089900 A discloses a configuration including individual fuel cells that are stacked one on top of the other, and having individual functional plates, in which each individual fuel cell has an additional plate with a positive temperature coefficients (PTC) element integrated in it as a self-controlling heating element. Furthermore, Japanese Patent document 61-044025 discloses a fuel cell having a liquid electrolyte, in which the electrolyte contains a thermal sensor that produces a signal to start the fuel cell when the temperature falls below a predetermined level.

### SUMMARY OF THE INVENTION

It is accordingly an object of the invention to provide a method for operating a PEM fuel cell system, and an associated polymer electrolyte membrane (PEM) fuel cell system that overcome the hereinafore-mentioned disadvantages of the heretofore-known devices and methods of this general type and that prevents the electrolyte from freezing or crystallizing out when it is not used for a lengthy period, and provides an associated fuel cell system with fuel cells, in which the temperature of an individual cell or of the stack is prevented from falling below a value that can be predetermined.

With the foregoing and other objects in view, there is provided, in accordance with the invention, a method for operating a fuel cell system having a rest phase, including the steps of providing at least one fuel cell module formed as a stack of individual PEM fuel cells having an electrolyte, and maintaining a temperature at least one of in the fuel cell and in the stack substantially above a freezing point of the electrolyte one of during and after the rest phase with a heating element disposed at least one of in each of the cells and in at least each stack and having an integrated thermal sensor.

A heating element with an integrated thermal sensor can be disposed in the membrane electrode unit (MEA) in PEM fuel cells. The method according to the invention is, thus, suitable for operation of a PEM fuel cell system, in which the temperature in the cell and/or in the stack is kept substantially above the freezing point of the electrolyte during the rest phase of the system through at least one heating element that is disposed in each cell and/or in at least each stack and has an integrated thermal sensor.

The heating element is, preferably, composed of a material that has a different resistance depending on the temperature. These materials have the characteristic that the resistance of the material rises drastically above a specific, material-specific temperature (reference temperature).

Examples of these materials are the so-called substances with high PTC, for example, ceramic substances, which are doped with elements having a higher valence than that in the crystal lattice. It is, thus, possible to select the material and/or the applied voltage to set the temperature at which the heating elements starts to heat up and switches off again. This means that the temperature in the cell does not fall significantly below the freezing point of the electrolyte, thus minimizing the starting time for the fuel cell system with little increase in the energy consumption. The capability of the material to indirectly measure the temperature through its own resistance is, in this case, referred to as a thermal sensor function, and a heating element composed of a material such as this is also referred to as a “heating element with an integrated thermal sensor.”

However, a heating element with an integrated thermal sensor may also be a two-part element that includes a temperature measuring element and a heating element. “Integrated” in this case means that only one component is present, rather than two separate elements. For example, a thermal sensor may be wound around a heating wire. The heating element with an integrated thermal sensor is, then, connected to a controller such that it is switched off automatically at a predetermined temperature that, for example, corresponds to the optimum operating temperature, and is switched on again at a minimum temperature that, for example, corresponds to the freezing point of the electrolyte. The optimum operating temperature is, in this case, defined as a maximum of the function of the efficiency of the stack plotted against temperature.

The expression “significantly above the freezing point” means, for example, in the case of the mobile use of the PEM fuel cell that is the primary consideration for the present invention, the time period during normal “stop and go” driving operation. A lengthy vehicle rest phase, for example, breaks when the vehicle is stationary while the vehicle keeper is away on holiday, must be excluded from this formulation because the maintenance of a minimum temperature in the stack and/or in the cell is, then, no longer desirable. It is, likewise, possible for the temperature in the stack/in the cell to fall below the freezing point of the electrolyte in quite short time periods, for example, prior to reaching the heating power, when the cooling runs on and/or when the outside temperatures are particularly low. These extreme and exceptional situations are also covered by the invention by the use of the expression “significant” or “substantially.”

The rest phase of the system is the time period in which the fuel cell system is switched off.

The heating element is, preferably, configured to be compact, that is to say, thin and narrow, such that, for example, it can be integrated in the electrolyte without needing to increase the volume of the electrolyte. In particular, in the case of PEM fuel cells, it shall be possible to dispose the heating element within the membrane electrode unit (membrane electrode assembly=MEA) as a major functional part of the fuel cell. The heating element has a connection for one or more voltage and energy sources, such as a battery, from which it is supplied with voltage/energy. To supply the heating element with power, the heating element is, for example, connected to the stack and/or to an additional voltage source. This means that the small amount of electrical power that is initially supplied when the fuel cell system is started up is used for further heating of the fuel cells, and, hence, in order to reach the operating power level quickly.

In accordance with another mode of the invention, the heating is selectively carried out with the heating element during a cold starting.

In accordance with a further mode of the invention, the heating element is driven with a controller by automatically switching the heating element at least one of on and off at a predetermined temperature.

In accordance with an added mode of the invention, the heating element is a plurality of heating elements and that also includes the step of driving the heating elements with a controller by automatically switching respective ones of the heating elements at least one of on and off at a predetermined temperature.

In accordance with yet another feature of the invention, the heating element is driven with a controller by automatically switching the heating element at least one of on and off at a predetermined temperature.

In accordance with yet a further mode of the invention, the heating elements is driven with a controller by automatically switching respective ones of the heating elements at least one of on and off at a predetermined temperature.

In accordance with an additional feature of the invention, heating elements are driven in groups.

With the objects of the invention in view, there is also provided a method for operating a fuel cell system having a rest phase, including the steps of providing at least one fuel cell module formed as a stack of individual PEM fuel cells having an electrolyte, placing a heating element having an integrated thermal sensor at least one of in each of the cells and in at least each stack, and maintaining a temperature at least one of in the fuel cell and in the stack substantially above a freezing point of the electrolyte one of during and after the rest phase with the heating element.

With the objects of the invention in view, there is also provided a PEM fuel cell system, including at least one PEM fuel cell having a membrane electrode unit, and at least one heating element with an integrated thermal sensor, at least the thermal sensor being disposed in the membrane electrode unit of the at least one PEM fuel cell.

In accordance with yet an added feature of the invention, there is provided a controller connected to the at least one heating element.

In accordance with yet an additional feature of the invention, there is provided a voltage source, the at least one PEM fuel cell having a stack, and the at least one heating element being connected to at least one of the stack and the voltage source for supplying electrical power to the at least one heating element.

In accordance with again another feature of the invention, there is provided an additional voltage source, the at least one PEM fuel cell formed as a stack of individual PEM fuel cells, and the at least one heating element being connected to at least one of the stack and the voltage source for supplying electrical power to the at least one heating element.

In the PEM fuel cell system, the heating element can be supplied by a partial load of at least part of the system. This energy source or its connection for the heating element can, preferably, be switched on and off so that, in the case of predictable relatively long rest phases of the system, no energy is consumed unnecessarily.

In accordance with again a further feature of the invention, the at least one PEM fuel cell is a PEM fuel cell module, a water supply container is fluidically connected to the fuel cell module, supply lines are connected at least to one of the water supply container and the PEM fuel cell module, and at least one of the water supply container and the supply lines have a heating element with an integrated thermal sensor.

In accordance with again an added feature of the invention, the heating element is a self-controlling PTC element.

With the objects of the invention in view, there is also provided a PEM fuel cell system having a rest phase, including at least one fuel cell module formed as a stack of individual PEM fuel cells having an electrolyte, the module having a membrane electrode unit, at least one heating element with an integrated thermal sensor, at least the thermal sensor being disposed at least in one of the membrane electrode unit, each of the fuel cells, and the stack, and the at least one heating element maintaining a temperature at least one of in the fuel cells and in the stack substantially above a freezing point of the electrolyte.

With the objects of the invention in view, there is also provided a PEM fuel cell system having a rest phase, including at least one fuel cell module formed as a stack of individual PEM fuel cells having an electrolyte, the module having a membrane electrode unit, at least one heating element with an integrated thermal sensor, at least the thermal sensor being disposed at least in one of the membrane electrode unit, each of the fuel cells, and the stack, and the at least one heating element maintaining a temperature at least one of in the fuel cells and in the stack substantially above a freezing point of the electrolyte one of during and after the rest phase.

With the objects of the invention in view, there is also provided a PEM fuel cell system having a rest phase, including at least one fuel cell module formed as a stack of individual PEM fuel cells having an electrolyte, the module having a membrane electrode unit, at least one heating element with an integrated thermal sensor, at least the thermal sensor being disposed at least in one of the membrane electrode unit, each of the fuel cells, and the stack, and the at least one heating element maintaining a temperature at least one of in the fuel cells and in the stack substantially above a freezing point of the electrolyte one of during and after the rest phase at operating temperatures between 80° C. and 250° C.

Other features that are considered as characteristic for the invention are set forth in the appended claims.

Although the invention is illustrated and described herein as embodied in a method for operating a PEM fuel cell system, and an associated polymer electrolyte membrane (PEM) fuel cell system, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWING

The figure is a fragmentary, schematic and block diagram of a fuel cell system with a fuel cell stack according to the invention having, for example, a number of fuel cells with elements for heating and detecting the temperature, and associated control and supply units.

### DESCRIPTION OF THE PREFERRED EMBODIMENTS

Referring now to the single figure of the drawing, it is seen that a fuel cell stack is annotated 1 and has a large number of individual fuel cells 10, 10′ . . . that are mechanically stacked one on top of the other but are electrically connected in series with one another. Also provided is an access line 2 and an outgoing line 3 for operating media, such as hydrogen (H₂) or hydrogen-rich gas, on one hand, as well as oxygen (O₂) or environmental air, on the other hand, as reactants for the fuel cell reaction and, in addition, a coolant that is, in particular, liquid.

In the figure, the individual fuel cells 10, 10′, . . . each have associated heating elements 100, 100′, . . . with integrated thermal sensors 100a, 100a′, . . . , that are not shown in detail. The heating elements 100, 100′, . . . are operatively connected to a supply device that, on one hand, detect signals from the thermal sensors 100a, 100a′, . . . that are integrated in the heating elements 100, 100′, . . . and, on the other hand, after processing of the signals, in each case supplies the power that is respectively required to stabilize the temperature of the individual fuel cells 10, 10′, . . . For such a purpose, an evaluation appliance 20 has a microprocessor for software-controlled evaluation of the signals supplied from the thermal sensors 100a, 100a′, . . . Furthermore, a unit 30 for supplying voltage and/or current is provided for producing electrical power and having individual switches 31, 31′, . . . that are associated with the heating elements 100, 100′, . . . , thus making it possible to individually drive the heating elements 100, 100′, . . . in the individual fuel cells 10, 10′, . . . A dedicated regulator may also be provided for each heating element 100, 100′, . . . , although this is not shown in the figure.

Such a configuration makes it possible to regulate the individual fuel cells individually at a predetermined temperature. Temperature regulation can also be also carried out based upon a predetermined algorithm. It is particularly advantageous to regulate the temperature of the heating elements selectively in groups. For example, if there are a hundred fuel cells, the first and the last twenty fuel cells and the central sixty fuel cells are each combined to form groups that, when driven jointly, lead to the expectation of a steady-state temperature distribution. PTC elements, in particular, are provided as suitable heating elements 100, 100′, . . . with an integrated thermal sensor. Due to the specific temperature dependency of the PTC material, elements such as these offer the capability to act equally well as a heating element and/or as a temperature sensor. This is particularly possible at these comparatively low electrical power levels.

At least one heating element is provided in each fuel cell unit and/or in each stack of the fuel cell system. Depending on the size of the individual heating element, it may also be advantageous to accommodate a number of heating elements in one fuel cell unit. The quantity, the size, the material, and the form of the heating element are dependent on the construction of the respective fuel cell system, and should in no way restrict the scope of the invention.

According to one embodiment, a heating element with an integrated thermal sensor or, for example, a thermally conductive sheath with a heating element having an integrated thermal sensor is also provided on or in the water supply container and/or on the lines of the system.

Preferred materials include metal and/or thermally conductive and/or electron-conductive plastic, carbon paper, fabric or the like in which, by way of example, a wire that is sheathed with plastic can be inserted.

The heating element has a preferred form, of course, such that it creates as little interference as possible in the component of the fuel cell unit in which it is integrated, and is damaged as little as possible during normal operation. The heating element can, thus, be integrated well as a bare metal wire both in the gas diffusion layer and in the pole plate of the respective fuel cell. The wire, which is coated, for example, with a thermally conductive plastic, is also advantageously accommodated or laminated in the electrolyte, for example, in the polymer membrane. In such a case, it is advantageous if the heating element also mechanically consolidates and/or strengthens the membrane or matrix.

The heating element is started independently of the operation of the fuel cell battery, as soon as the temperature results in the resistance of the material falling below the value of the applied voltage.

According to one refinement, the external energy source is a rechargeable battery and/or a battery that, for example, can be recharged during operation through the fuel cell system. The external energy source may, however, just as well be an electrical connection to a power supply network, for example, to an existing power supply system network. According to one specific embodiment of the invention, the heating element is integrated in one gas diffusion layer, or in both gas diffusion layers, of a fuel cell unit.

A fuel cell system includes at least one stack having at least one fuel cell unit, the corresponding process gas supply and output channels (process gas channel), a cooling system, and associated end plates. The PEM fuel cells furthermore include at least one electrolyte, to which electrodes are connected on both sides and that form the MEA, to which, in turn, a gas diffusion layer is adjacent, through which the reaction gas diffuses in the reaction chamber to the electrode for conversion. The electrodes include, for example, an electrical catalyst layer, while the gas diffusion layer is formed, for example, by a carbon paper.

The invention allows faster cold starting by a heating element that is incorporated in the cell and/or in the stack. The heating element has an integrated thermal sensor so that it is substantially possible to prevent the temperature of the system/of the cell falling below the freezing point of the electrolyte.

The invention is particularly suitable for fuel cell systems with so-called high-temperature (HT) PEM fuel cells. HT-PEM fuel cells are operated at operating temperatures that are 60° C. to 80° C. higher than the normal operating temperatures for PEM fuel cells, to be precise, in particular, in the range between 80° C. and 250° C. HT-PEM-fuel cells such as these operate with an electrolyte based on phosphoric acid, which solidifies at approximately 42° C., although the solidification temperature, or the melting point, can be reduced by adding water. This may be done by taking water from the existing water supply container, which is otherwise used for water to be taken from while the HT-PEM fuel cell is being heated up. In contrast, the method of operation of the HT-PEM fuel cell at its operating temperature is advantageously independent of water. The use of the heating elements in the sense according to the invention makes it possible to reach the operating temperature quickly when starting the fuel cell system.

We claim:

1. A method for operating a fuel cell system having a rest phase, which comprises:
providing at least one fuel cell module formed as a stack of individual PEM fuel cells having an electrolyte; and
maintaining a temperature at least one of in the fuel cell and in the stack substantially above a freezing point of the electrolyte one of during and after the rest phase with a heating element disposed at least one of in each of the cells and in at least each stack and having an integrated thermal sensor.

2. The method according to claim 1, which further comprises selectively carrying out the heating with the heating element during a cold starting.

3. The method according to claim 1, which further comprises driving the heating element with a controller by automatically switching the heating element at least one of on and off at a predetermined temperature.

4. The method according to claim 1, wherein the heating element is a plurality of heating elements and which further comprises driving the heating elements with a controller by automatically switching respective ones of the heating elements at least one of on and off at a predetermined temperature.

5. The method according to claim 4, which further comprises driving a number of heating elements in groups.

6. The method according to claim 2, which further comprises driving the heating element with a controller by automatically switching the heating element at least one of on and off at a predetermined temperature.

7. The method according to claim 2, wherein the heating element is a plurality of heating elements and which further comprises driving the heating elements with a controller by automatically switching respective ones of the heating elements at least one of on and off at a predetermined temperature.

8. The method according to claim 7, which further comprises driving a number of heating elements in groups.

9. A method for operating a fuel cell system having a rest phase, which comprises:
providing at least one fuel cell module formed as a stack of individual PEM fuel cells having an electrolyte;
placing a heating element having an integrated thermal sensor at least one of in each of the cells and in at least each stack; and
maintaining a temperature at least one of in the fuel cell and in the stack substantially above a freezing point of the electrolyte one of during and after the rest phase with the heating element.

10. A PEM fuel cell system, comprising:
at least one PEM fuel cell having a membrane electrode unit; and
at least one heating element with an integrated thermal sensor, at least said thermal sensor being disposed in said membrane electrode unit of said at least one PEM fuel cell.

11. The PEM fuel cell system according to claim 10, including a controller connected to said at least one heating element.

12. The PEM fuel cell system according to claim 10, including a voltage source, said at least one PEM fuel cell having a stack, and said at least one heating element being connected to at least one of said stack and said voltage source for supplying electrical power to said at least one heating element.

13. The PEM fuel cell system according to claim 10, including an additional voltage source, said at least one PEM fuel cell formed as a stack of individual PEM fuel cells, and said at least one heating element being connected to at least one of said stack and said voltage source for supplying electrical power to said at least one heating element.

14. The PEM fuel cell system according to claim 10, including a partial load on at least a part of the fuel cell system, said at least one heating element being fed by said partial load.

15. The PEM fuel cell system according to claim 10, wherein said at least one heating element is fed by a partial load on at least a part of the system.

16. The PEM fuel cell system according to claim 10, wherein:
said at least one PEM fuel cell is a PEM fuel cell module;
a water supply container is fluidically connected to said fuel cell module;
supply lines are connected at least to one of said water supply container and said PEM fuel cell module; and
at least one of said water supply container and said supply lines have a heating element with an integrated thermal sensor.

17. The PEM fuel cell system according to claim 10, wherein:
said at least one PEM fuel cell is a PEM fuel cell module;
a water supply container is fluidically connected to said fuel cell module;
supply lines are connected at least to one of said water supply container and said PEM fuel cell module; and
at least one of said water supply container and said supply lines have said at least one heating element with said integrated thermal sensor.

18. The PEM fuel cell system according to claim 10, wherein said at least one heating element is a self-controlling PTC element.

19. The PEM fuel cell system according to claim 16, wherein at least one of said at least one heating element and said heating element is a self-controlling PTC element.

20. The PEM fuel cell system according to claim 17, wherein said at least one heating element is a self-controlling PTC element.

21. A PEM fuel cell system having a rest phase, comprising:
at least one fuel cell module formed as a stack of individual PEM fuel cells having an electrolyte, said module having a membrane electrode unit;
at least one heating element with an integrated thermal sensor, at least said thermal sensor being disposed at least in one of:
said membrane electrode unit;
each of said fuel cells; and
said stack; and
said at least one heating element maintaining a temperature at least one of in said fuel cells and in said stack substantially above a freezing point of said electrolyte.

22. A PEM fuel cell system having a rest phase, comprising:
at least one fuel cell module formed as a stack of individual PEM fuel cells having an electrolyte, said module having a membrane electrode unit;
at least one heating element with an integrated thermal sensor, at least said thermal sensor being disposed at least in one of:
said membrane electrode unit;
each of said fuel cells; and
said stack; and
said at least one heating element maintaining a temperature at least one of in said fuel cells and in said stack substantially above a freezing point of said electrolyte one of during and after the rest phase.

23. A PEM fuel cell system having a rest phase, comprising:
at least one fuel cell module formed as a stack of individual PEM fuel cells having an electrolyte, said module having a membrane electrode unit;
at least one heating element with an integrated thermal sensor, at least said thermal sensor being disposed at least in one of:
said membrane electrode unit;
each of said fuel cells; and
said stack; and
said at least one heating element maintaining a temperature at least one of in said fuel cells and in said stack substantially above a freezing point of said electrolyte one of during and after the rest phase at operating temperatures between 80° C. and 250° C.
